(19) United States
(12) Patent Application Publication
(10) Pub. No.: US 2016/0332789 A1
(43) Pub. Date: Nov. 17, 2016

(54) Resealable Label With Tamper Evident Feature

(71) Applicant: Arthur Charles Yerecic, Monroeville, PA (US)

(72) Inventor: Arthur Charles Yerecic, Monroeville, PA (US)

(73) Assignee: Yerecic Label, Co., New Kensington, PA (US)

(21) Appl. No.: 14/711,970

(22) Filed: May 14, 2015

(51) Int. Cl. B65D 55/02; G09F 3/02

(52) U.S. Cl. CPC B65D 55/024; G09F 3/02; B65D 2555/025; G09F 2003/0222; G09F 2003/0227; G09F 2003/0272; G09F 2003/0277

(57) ABSTRACT

A resealable label is provided that has a body with adhesive, and a peel tab adjacent to the body with adhesive for releasable attachment. A tamper evident tab is adjacent the peel tab, and perforations are between the peel tab and the tamper evident tab. The tamper evident tab has adhesive. A grasping tab is adjacent to the peel tab, and pulling of the grasping tab causes the peel tab to be torn from the tamper evident tab.

### FIELD OF THE INVENTION

The present invention relates generally to a label that can be used to repeatedly seal a container. More particularly, the present application relates to a resealable label with a tamper evident feature that informs the user that the label has been initially opened.

### BACKGROUND

Containers for objects, for example food items, often include a frame with an opening that is closed by a lid. The lid may snap into indents in the frame of the container to cause the lid to be attached to the frame and the opening to be closed. One type of container is known as a clamshell style container in which the lid is permanently attached to a bottom portion of the container by means of a hinge. The lid can be pivoted into an open position to allow access to the interior of the container and the contents of the container. It may be the case that a person could open a container and remove or tamper with the food items therein. The person could then close the container, and a subsequent customer may pick up and purchase the container with the tampered or removed food items. For these reasons, especially, with respect to food items, consumers want assurances that the contents of the container have not been tampered with before purchase.

To provide assurances that the contents of a container have not been removed or tampered with, it is known to provide containers with tamper evident features. One such container that includes tamper evident features has a plurality of strips that are die cut into a wrapper making up the container. A flap closes an opening of the container and includes adhesive to hold the flap to the container. When a user first opens the container, pulling of the flap causes the adhesive to disengage to cause the flap to open, while at the same time the adhesive on top of the strips causes the strip to be disengaged from the wrapper. Continued pulling causes the flap to be removed from the strips, and the now free strips to fall into the container. The user will know that the container has been initially opened because the strips in the container will be seen through the transparent flap.

Another type of tamper evident feature on a container includes a container that has a positive image printed onto the container upper surface with a negative image engaging the positive image on a grasping tab of a flap of the container. In the closed position, adhesive holds the flap onto the upper surface of the container to close an opening in the upper surface. When the grasping tab is grabbed and pulled by the user, the positive image separates from the negative image and remains on the bottom surface of the grasping tab. The flap is pulled away from the container to reveal the negative image left behind on the upper surface of the container. A user will thus know that the container has been initially opened when viewing the two images as they will not line up when the flap is reapplied into the closed position.

A still further tamper evident feature may be found on a package of wet wipes that features a flap attached to an upper surface of a flexible body that covers an opening in the upper surface. The flap includes a grasping tab that is devoid of adhesive or otherwise provided so that the adhesive of the grasping tab does not function to adhere the grasping tab to the upper surface of the container. A tamper indicating tab is provided with the grasping tab and does include adhesive so that the tamper indicating tab is adhered to the upper surface of the flexible body. The tamper indicating tab has a pair of straight perforations that are linearly oriented and intersect at a ninety degree angle. There is no adhesive present on one side of the perforations as the grasping tab is again devoid of adhesive or otherwise provided so that there is no adhesive with holding power present. Initial opening of the flap causes the grasping tab to be lifted up, the perforations to be torn, and the adhesive on the flap to be overcome so that the flap is removed and the opening revealed to access the wet wipes therein. The tamper indicating tab remains adhered to the upper surface of the flexible body to indicate that initial opening has taken place. Although containers are known that include tamper indicating features, there remains room for variation and improvement within the art.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended Figs. in which:

FIG. 1 is a perspective view of a resealable label attached to a container in a closed position.

FIG. 2 is a perspective view of the container of FIG. 1 in which the resealable label has been opened.

FIG. 3 is a bottom plan view of a resealable label with laterally oriented linear strips of UV deadener in accordance with one exemplary embodiment.

FIG. 4 is a bottom plan view of a resealable label similar to that of FIG. 3 but with a different number and size of linear strips of UV deadener.

FIG. 5 is bottom plan view of a resealable label with UV deadener on a peel tab that is provided in a pattern of circles.

FIG. 6 is a bottom plan view of a resealable label with linear strips of UV deadener on the peel tab arranged in a longitudinal direction.

FIG. 7 is a bottom plan view of a resealable label with a body that includes adhesive along its entire longitudinal length.

FIG. 8 is a bottom plan view of a resealable label with first and second series of perforations that are oriented along common lines.

FIG. 9 is a bottom plan view of a resealable label in which details of overlapping perforations are disclosed.

FIG. 10 is a bottom plan view of a resealable label that includes overlapping perforations that each have a curved section and a linear section.

FIG. 11 is a bottom plan view of a resealable label similar to that of FIG. 10 but with perforations that are different in arrangement.

FIG. 12 is a bottom plan view of a resealable label with overlapping perforations that are linear in shape.

FIG. 13 is a bottom plan view of a resealable label with overlapping perforations that are linear in shape, and sized and numbered differently than the embodiment in FIG. 12.

Repeat use of reference characters in the present specification and drawings is intended to represent the same or analogous features or elements of the invention.

### DETAILED DESCRIPTION OF REPRESENTATIVE EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5.

The present invention provides for a resealable label 10 that can function as a closure for a container 12. The resealable label 10 is releasably attachable to the container 12 so that the resealable label 10 and container 12 can be repeatedly opened and closed. The resealable label 10 includes a tamper evident feature in the form of one or more tamper evident tabs 24, 52 that are initially attached to a surface 56 of the container 12 when the resealable label 10 is initially attached. Upon initial opening, first and/or second series of perforations 28, 30 are torn such that the tamper evident tabs 24, 52 remain on the surface 56 of the container 12 while portions of the resealable label 10, such as a peel tab 20 and grasping tab 32, are detached from the container 12 and moved out of engagement therewith. Upon reclosure, the resealable label 10 may again be reapplied into its closed position, but the tearing of the first and second series of perforations 28, 30 will be evident and one will know that the resealable label 10 and container 12 have been at some point in the past opened.

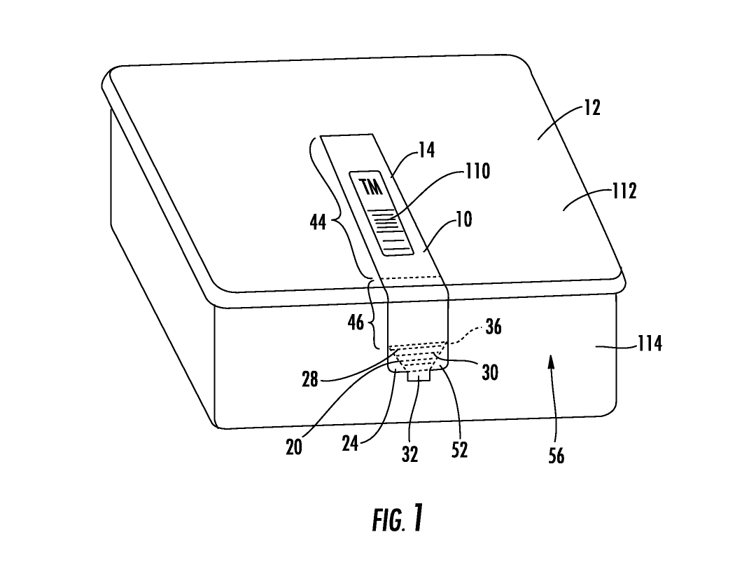

FIG. 1 shows an exemplary embodiment of a resealable label 10 attached to a container 12 in the closed position. The container 12 may be a clam shell type container in some embodiments. The container 12 can include a bottom portion 114 that holds the contents of the container 12 and that has an open top that is covered by a lid 112. The lid 112 is hingedly connected to the bottom portion 114 and these two components 112, 114 may include indents and projections or other features that assist in their attachment when moved into the closed position. The resealable label 10 may be attached to the upper surface of the lid 112 and can extend down onto a surface 56 of the bottom portion 114. Although shown as being on a side wall, the surface 56 could be on the bottom wall of the bottom portion 114 in other embodiments and it is to be understood that the surface 56 need not be a side wall of the bottom portion 114 and can be any one of or several of the walls of the bottom portion 114 or any other part of the container 12 such as the lid 112 when the label 10 is arranged in a different manner. The resealable label 10 itself may function to hold the lid 112 to the bottom portion 114, or may assist in so doing with other closure mechanisms possible between the two components 112, 114. Further, in yet other embodiments, the resealable label 10 does not provide any closure holding to the lid 112 and bottom portion 114.

The container 12 may be rigid in that the surface 56 is not a flexible surface but instead one that maintains its shape in normal use. Further, the entire lid 112 and bottom portion 114 may also be non-flexible in that they do not change shape during normal use of the container 12.

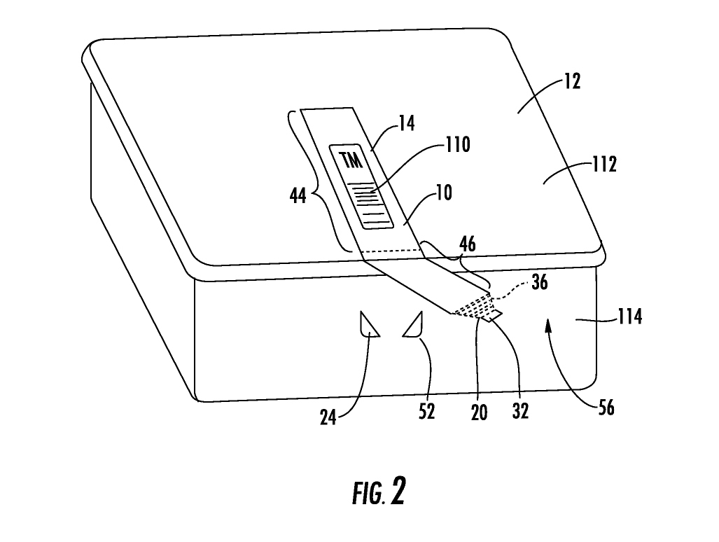

The resealable label 10 is shown in its initially closed state in FIG. 1 such that the container 12 has not been previously opened after application of the resealable label 10. A pair of tamper evident tabs 24, 52 are visible to the consumer or user of the container 12 on the surface 56 and attached to a peel tab 20. The person will know that the resealable label 10 has not been initially opened, and thus will know that the contents of the container 12 have not been tampered with upon their initial inclusion and closure of the container 12 due to the fact that the tamper evident tabs 24, 52 are attached to the peel tab 20. Grasping of a grasping tab 32 and pulling thereon will cause the peel tab 20 and portions of the body 14 of the resealable label 10 to detach from the surface 56. This detachment is shown in FIG. 2. Doing so will cause the first and second series of perforations 28, 30 to tear to allow the peel tab 20 to be detached. The first and second tamper evident tabs 24, 52 remain on the surface 56 when the resealable label 10 is detached. The tamper evident tabs 24, 52 thus serve as an indication to the user that the resealable label 10 has been initially opened. The resealable label 10 may include indicia 110 on an upper surface of the body 14 that can include information such as the identification of contents of the container 12, nutritional information, preparation directions, trademarks, advertising, or other information.

The body 14 may include an adhesive section 44 that remains attached to the lid 112 even when the peel tab 20 is detached. The body 14 may also include a deadened adhesive section 46 that is itself not adhered to the container 12 and that will be detached or be moved away from the container 12 when the peel tab 20 is removed. After the user has accessed the contents of the container 12 he or she may close the lid 112 and reseal the resealable label 10. In this regard, the peel tab 20 may include adhesive 22 thereon to allow for subsequent attachment and removal. Reattachment of the peel tab 20 to the surface 56 will function to reseal the resealable label 10 so that the container 12 is again closed by the resealable label 10 as were the case when initially sealed. However, due to the fact that the first and second series of perforations 28 and 30 were broken, this portion of the resealable label 10 will be different after the initial opening and subsequent reattachment. In this regard, the first and second tamper evident tabs 24, 52 will not line up in the same manner with the peel tab 20 and visual evidence of their tearing should be noted by the user. The user should thus know that the resealable label 10 has been initially opened and reattached to indicate tampering.

The resealable label 10 thus allows one to reseal the container 12 after repeated openings and closings to maintain freshness of the product stored therein. Instructions on how to open and reseal the label, along with the tamper evident feature may be displayed on the indicia 110 or on other areas of the resealable label 10. Although shown as being attached to the top of the lid 112, and to the surface 56 of a side wall of the bottom portion 114 of the container 12, it is to be understood that the resealable label 10 may be attached to any of the surfaces of the container 12 in accordance with other exemplary embodiments. For example, the body 14 may be attached to both the upper surface of the lid 112 and the surface 56 of a side wall of the bottom portion 114, and the peel tab 20 and tamper evident tabs 24, 52 may be attached to the bottom surface of the bottom portion 114 in accordance with other exemplary embodiments. Here, the user will reach under the container 12 to grasp the grasping tab 32 and pull same along the bottom wall of the bottom portion 114 and cause removal of a portion of the body 14 that is at the surface 56 to allow for opening of the container 12. As such, it is to be understood that the positioning of the resealable label 10 as illustrated in FIGS. 1 and 2 is only exemplary and that other arrangements of the resealable label 10 with respect to the container 12 are possible in other exemplary embodiments.

The resealable label 10 may be applied to the container 12 so that it closes the container 12 but does not keep the container 12 airtight. The container 12 may be closed in that the resealable label 10 provides some degree of resistance to opening the container 12. The resealable label 10 may be sized so that it does not extend across the entire engaging surfaces of the lid 112 and the bottom portion 114, but has a width in the lateral direction 40 that only covers a portion of the areas of engagement of the lid 112 and bottom portion 114.

FIG. 3 is a bottom plan view of a resealable label 10 in accordance with one exemplary embodiment that has a body 14 with an adhesive section 44 that extends along the majority of the longitudinal length of the body 14. Adhesive 18 may be applied along the entire lower surface 96 of the body 14 that is present in the adhesive section 44. The adhesive 18 may be of a strength that affords permanent attachment to a surface of the container 12. In this regard, the adhesive section 44 is not designed to be removed and reapplied to the container 12 but is instead meant to be attached to the container 12 throughout the life of the container 12. A deadened adhesive section 46 of the body 14 extends from the adhesive section 44 in the longitudinal direction 16. The length of the deadened adhesive section 46 in the longitudinal direction 16 may be less than the longitudinal length of the adhesive section 44 in the longitudinal direction 16. The deadened adhesive section 46 may be devoid of adhesive 18 with any tack across the entire area of the lower surface 96 of the body 14 in the deadened adhesive section 46. The body 14 may have a consistent width in the lateral direction 40 such that a first lateral edge 48 of the resealable label 10 is parallel to an opposite second lateral edge 50 of the resealable label 10. The width of the body 14 in the lateral direction 40 may thus be the same along the entire length of the body 14 in the longitudinal direction 16.

The resealable label 10 includes a peel tab 20 that is adjacent to the deadened adhesive section 46. The peel tab 20 includes deadened adhesive 22 to allow for the peel tab 20 to be releasably attachable to the container 12. In this regard, the adhesive 22 of the peel tab 20 is provided in such a manner that the peel tab 20 can be repeatedly attached, removed from, and then reattached to the container 12 a number of times. The adhesive 22 may be deadened to allow for releasable attachment of the peel tab 20 in a variety of manners. For example, certain types of adhesive 22 that display a tackiness sufficient to allow for attachment, removal, and subsequent reattachment may be provided. Additionally or alternatively, the provision of adhesive 22 on the peel tab 20 may be such that it does not cover the entire surface of the peel tab 20 but instead covers less than the entire surface. FIG. 3 shows an arrangement where the adhesive 22 is provided in a series of linear strips 36 that extend in the lateral direction 40. The series of linear strips 36 are separated by a series of deadened adhesive sections 38 that likewise extend in the lateral direction 40. The linear strips 36 may all have the same length in the longitudinal direction 16, and may all be parallel to one another in accordance with certain exemplary embodiments. In a similar manner, the deadened adhesive sections 38 may likewise also have the same length in the longitudinal direction 16 and be parallel to one another. The peel tab 20 is arranged in the shape of a truncated pyramid in that the width of the peel tab 16 narrows in the lateral direction 40 upon its extension away from the body 14 in the longitudinal direction 16. The peel tab 20 ends at a truncated end 34 that is adjacent to the grasping tab 32. The truncated end 34 has a width in the lateral direction 40 that in some embodiments may be approximately one-third of the width of the body 14 in the lateral direction 40.

The peel tab 20 has deadened adhesive 22 in that the adhesive 22 is arranged on the peel tab 20 so as to allow for the peel tab 20 to be releasably attached to the container 12. The inclusion of the linear strips 36 separated by the deadened adhesive sections 38 gives the peel tab 20 a reduced adhesive strength from that which it would otherwise experience. This reduced adhesive strength allows for the peel tab 20 to be attached to the surface 56 of the container 12, removed therefrom, and subsequently attached and detached. Reduction of the adhesive strength of the peel tab 20 allows the peel tab 20 to be released from the surface 56 of the container 12 without tearing as the release strength is appropriately selected. Although 16 linear strips 36 are present in the peel tab 20 of FIG. 3, it is to be understood that any number of linear strips 36 may be present in other exemplary embodiments. For example, from 3-5, 6-10, 11-20, 21-30, or up to 50 linear strips 36 may be present in accordance with other exemplary embodiments.

The deadened adhesive of the peel tab 12 allows for the resealable label 10 to be removed and reapplied and stay adhered to the container 12 through multiple removals and reapplications. The pattern of the adhesive 12 of the peel tab 20 may allow for the right amount of adhesive properties to be imparted to the peel tab 20 to allow for the attachment, multiple removals and subsequent reapplications. The adhesive 22 of the peel tab 20 may be as strong as the adhesive 18 of the body 14, but the overall holding strength of the peel tab 20 may be less than that of the body 14 because the adhesive 22 is provided in the aforementioned patterns where deadened adhesive sections 38 of the peel tab 20 are present.

A first series of perforations 28 extend along one side of the peel tab 20, and a second series of perforations 30 extend along the opposite side of the peel tab 20. The first series of perforations 28 extends from the first lateral edge 48 towards the grasping tab 32. The first series of perforations 28 extend inboard in the lateral direction 40 towards a longitudinal centerline 58 of the resealable label 10 upon their extension in the longitudinal direction 16 away from the body 14. In a similar manner, the second series of perforations 30 extend from the second lateral edge 50 of the resealable label 10 so that they extend inboard in the lateral direction 40 towards the longitudinal centerline 58 upon their extension away from the body 14 in the longitudinal direction 16. The first and second series of perforations 28 and 30 are made of a plurality of individual perforations that extend either partially or completely through the depth of the resealable label 10. Although shown as being symmetrical about the longitudinal centerline 58, it is to be understood that the first and second series of perforations 28 and 30 need not extend in a symmetrical manner and thus may be oriented and configured differently with respect to one another about the longitudinal centerline 58. The first series of perforations 28 are located between the peel tab 20 and the first tamper evident tab 24. The second series of perforations 30 are located between the peel tab 20 and the second tamper evident tab 52. The first and second series of perforations 28 and 30 terminate at the grasping tab 32.

The resealable label 10 includes a first tamper evident tab 24 that has adhesive 26 located thereon. The adhesive 26 is selected to be of such a strength that it causes the tamper evident tab 24 to be permanently attached to the surface 56 of the container 12 when the resealable label 10 is initially applied. Pulling of the peel tab 20 so that the first series of perforations 28 are torn causes lifting and removal of the peel tab 20 from the surface 56. The strength of the adhesive 26 causes the tamper evident tab 24 to remain on the surface 56 when the peel tab 20 is lifted to inform the user that the resealable label 10 has been opened from its initially closed state. The first series of perforations 28 are thus arranged so that a tamper evident tab 24 with adhesive 26 is on one side of the first series of perforations, and a peel tab 20 with adhesive 22 is on the opposite side of the first series of perforations 28. As such, adhesive is located on both sides of the first series of perforations 28. Adhesive may be located immediately adjacent the first series of perforations 28 on opposite sides of the first series of perforations 28. Adhesive can be present on opposite sides of the perforations of the first series 28 such that adhesion engages the perforations on either side, or such that adhesion is present such that no portion of a liner or other part of the label 10 is visible other than the adhesion on opposite sides. The tamper evident tab 24 has a triangular configuration. However, it is to be understood that the tamper evident tab 24 need not be triangular in accordance with other exemplary embodiments.

A second tamper evident tab 52 is provided and includes adhesive 54 located on its entire lower surface. The adhesive 54 is selected to be of such a strength that the second tamper evident tab 52 remains on the surface 56 when the peel tab 20 is pulled and the second series of perforations 30 are torn. The second tamper evident tab 52 may be provided so that it is symmetrical with the first tamper evident tab 24 in shape about the longitudinal centerline 58. The second tamper evident tab 52 borders the peel tab 20 with the second series of perforations 30 located therebetween such that adhesive is immediately adjacent the second series of perforations 30 on opposite sides of the second series of perforations 30. The second series of perforations 30 extends from the second lateral edge 50 and terminate at the grasping tab 32. The grasping tab 32 is shown as being rectangular in shape in the embodiment of FIG. 3. However, it is to be understood that the grasping tab 32 may be variously shaped and configured in accordance with other exemplary embodiments of the resealable label 10. The grasping tab 32 has had the adhesive normally present deadened. The user will grasp the grasping tab 32 and pull same in order to detach the peel tab 20 and the deadened adhesive section 46 of the resealable label 10 from the container 12 in order to allow for opening of the container 12 and access to the contents therein.

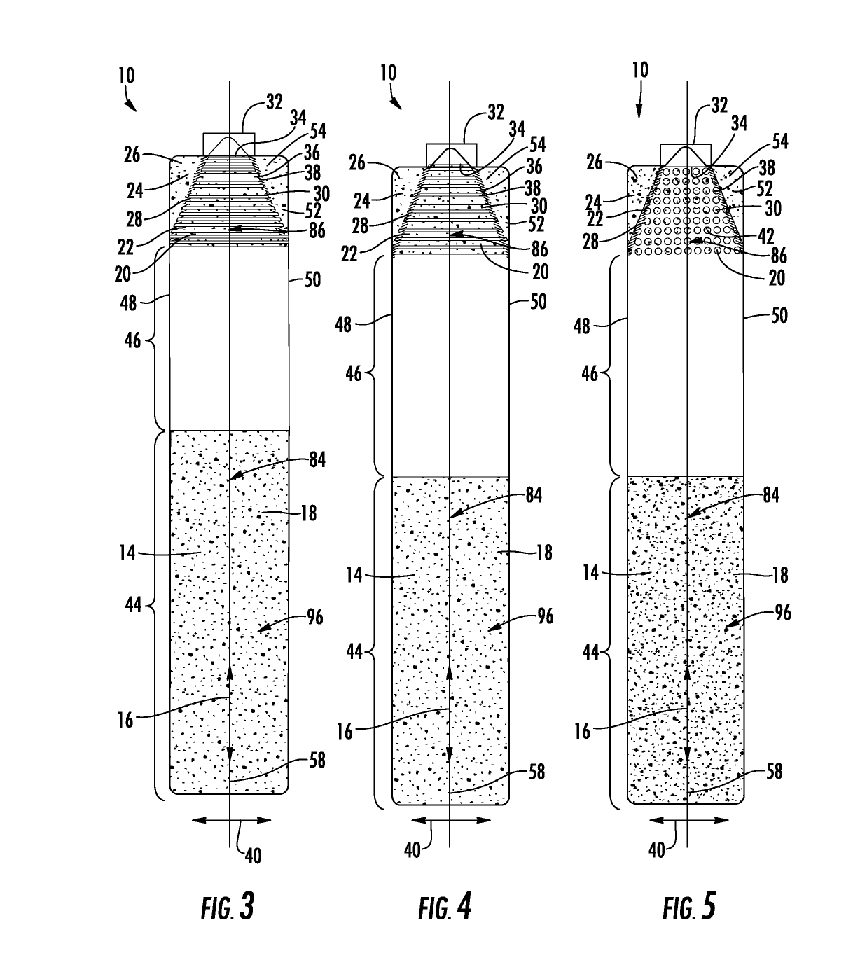

FIGS. 4 through 7 show alternative arrangements of the body 14 and the peel tab 20 of the resealable label 10 from that disclosed in FIG. 3. With reference to FIG. 4, the peel tab 20 is provided with a reduced number of linear strips 36. Here, 10 linear strips 36 of adhesive 22 are provided and are separated from one another by 10 strips of deadened adhesive section 38. The linear strips 36 are longer in the longitudinal direction 16 than the linear strips 36 of the FIG. 3 embodiment. The linear strips 36 and the deadened adhesive sections 38 are arranged so as to extend in the lateral direction 40 and to be parallel to one another. The deadened adhesive section 46 is again present between the peel tab 20 and the adhesive section 44. However, the deadened adhesive section 46 of the FIG. 4 embodiment has a longer length in the longitudinal direction 16 than the deadened adhesive section 46 of the embodiment in FIG. 3. Likewise, the adhesive section 44 of the body 14 is shorter in the longitudinal direction 16 than the corresponding adhesive section 44 of the FIG. 3 embodiment. The overall length and width of the resealable label 10 is the same in all of the embodiments disclosed in FIGS. 3-7.

FIG. 5 shows an alternative arrangement of the resealable label in which the peel tab 20 does not include the linear strips 36 of adhesive 22. Instead, the adhesive 22 is provided in a plurality of circles 42 that are uniformly distributed across the entire lower surface of the peel tab 20. The circles 42 of adhesive 20 are separated from one another by the deadened adhesive section 38 of the peel tab 20. The circles 42 all have the same diameter and are arranged in a series of evenly spaced rows and columns. The circles 42 terminate at the first and second series of perforations 28 and 30 such that they are inside of the first and second series of perforations 28 and 30 but do not extend into the first and second tamper evident tabs 24 and 52. Again, adhesive is present on both sides of the first and second tamper evident tabs 24 and 52 in the FIG. 5 embodiment. The body 14 in FIG. 5 is arranged in a similar manner as the body 14 in FIG. 4. The circles 42 of adhesive 22 result in a deadened adhesive quality being imparted to the peel tab 20 so that the peel tab 20 can be removed from the surface 56 without tearing and then subsequently reattached. The deadened adhesive of the peel tab 20 thus allows for multiple detachments and reattachments to the surface 56 to cause a resealable label 10 to be reusable.

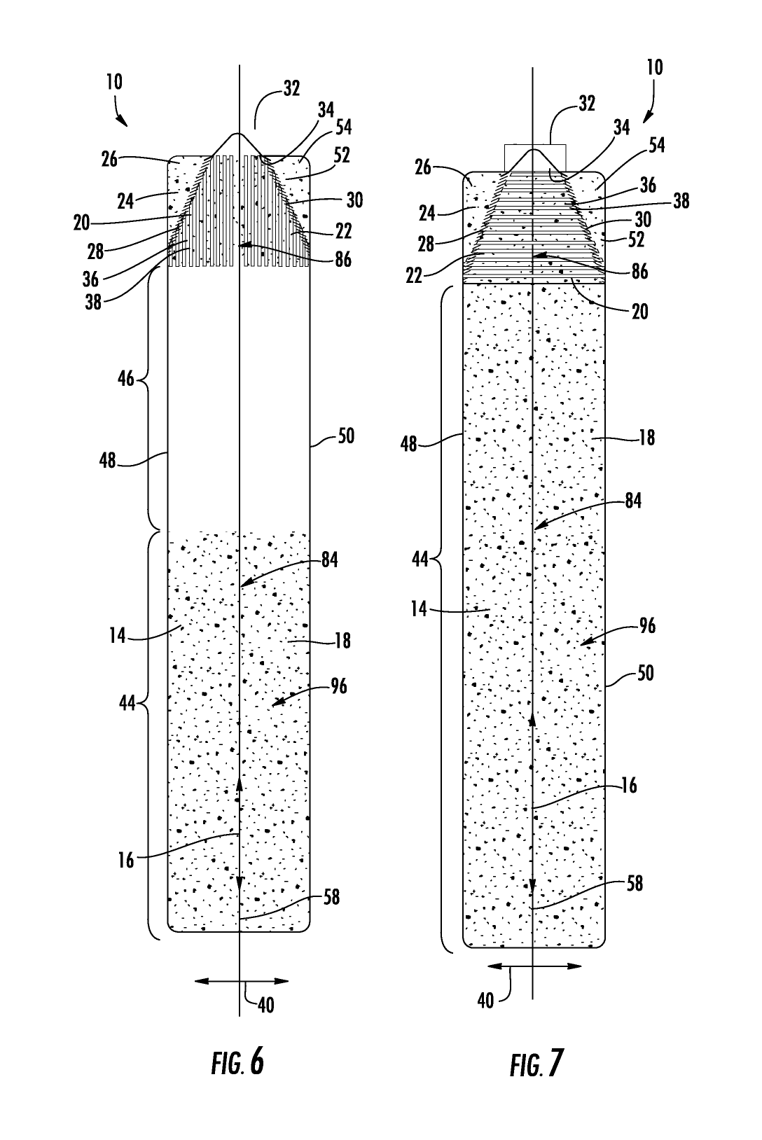

FIG. 6 shows another alternative arrangement of the resealable label 10 in which the body 14 is the same as that previously disclosed with respect to the embodiments in FIGS. 4 and 5. The peel tab 20 differs from previously discussed embodiments in that the linear strips 36 extend in the longitudinal direction 16 instead of in the lateral direction 40. The linear strips 36 are evenly spaced in the lateral direction 40 and all have an equal width in the lateral direction 40. A plurality of deadened adhesive sections 38 are located between the linear strips 36. The deadened adhesive sections 38 also extend in the longitudinal direction 16 and all have an equal width in the lateral direction 40. The linear strips 36 and the deadened adhesive sections 38 are all parallel to one another. The linear strips 36 extend from the deadened adhesive section 46 to the grasping tab 32. Adhesive 22 of the linear strips 36 is again positioned so that adhesive is on either opposite side of the first and second series of perforations 28 and 30 relative to the first and second tamper evident tabs 24 and 52. Although 21 linear strips 36 are shown in the FIG. 6 embodiment, it is to be understood that any number of the longitudinally disposed linear strips 36 may be present in accordance with other exemplary embodiments.

FIG. 7 shows another alternative arrangement of the resealable label 10. The peel tab 20 is provided so that the linear strips 36 extend in the lateral direction 40, and have the same length in the longitudinal direction 16. The linear strips 36 of adhesive 22 have a greater length in the longitudinal direction 16 than do the deadened adhesive sections 38. Although 13 linear strips 36 are illustrated, it is to be understood that any number may be present in accordance with the other exemplary embodiments. Also, although disclosed as having linear strips 36 that have the same width and/or length, it is to be understood that the linear strips 36 may be variously provided in accordance with other exemplary embodiments so that their lengths and/or widths may be different from one another. The body 14 includes an adhesive section 44 in which adhesive 18 is present on the entire lower surface 96 of the body 14. The body 14 lacks a deadened adhesive section 46 as was present in previously described embodiments. Adhesive 18 does extend all the way to the peel tab 20. It is to be understood that the body 14 can be provided with sections of adhesive and sections that are deadened adhesive as may be desired to allow the resealable label 10 to work in various applications. Also, although described as having some portion of the peel tab 20 lacking adhesive 22 with any tack due to its being deadened, it is to be understood that the entire surface of the peel tab 20 may be provided with adhesive 22 in accordance with various exemplary embodiments.

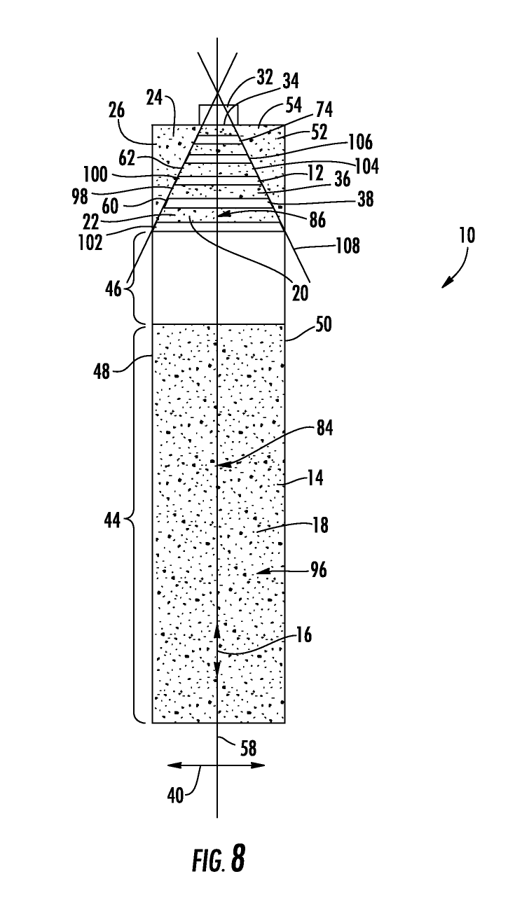

FIG. 8 shows an alternative embodiment of the resealable label 10 with features primarily the same as previously described embodiments with respect to the adhesive section 44, deadened adhesive section 46, tamper evident tabs 24, 52, and peel tab 20 with laterally extending linear strips 36. The first series of perforations 28 are made of a plurality of perforations having a line shape. Two successive perforations 60 and 62 are labeled for discussion. Perforation 60 has an end 98 that is adjacent to an end 100 of the successive perforation 62. The perforations 60 and 62 are thus aligned end to end along a common line 102. All of the perforations of the first series of perforations 28 are thus linear in shape in that they are lines and are all arranged end to end along the common line 102.

The second series of perforations 30 are arranged in a similar manner. In this regard, a first perforation 72 is located next to a successive second perforation 74. The perforations 72 and 74 are arranged end to end such that the end 104 of the first perforation 72 is next to the end 106 of the next successive second perforation 74. All of the perforations of the second series of perforations 30 are line shaped and are arranged in a linear manner so that they all extend along the common line 108. The common lines 102 and 108 are symmetrical about the longitudinal centerline 58. The peel tab 20 may again be configured in a triangular shape that has a truncated end 34 that is adjacent to the grasping tab 32.

The various perforations of the first and second series of perforations 28 and 30 in FIG. 8 are all arranged in a linear manner and are all line shaped. As such, there is no overlap of any of the perforations so that all of the perforations have a unique distance from the longitudinal centerline 58 that extends in the longitudinal direction 16 through the center 86 of the peel tab 20. Grasping of the grasping tab 32 and pulling of same will cause a force to be imparted onto the peel tab 20 that will in turn cause the perforations of the first and second series of perforations 28, 30 to tear. The arrangement of the perforations in FIG. 8 may cause the middle of the resealable label 10 to tear when the grasping tab 32 is pulled and the resealable label 10 is detached. This may be due to the linear geometry of the perforations in the series of perforations 28 and 30 as arranged along the common lines 102 and 108. The perforations of the series 28, 30 may also not overlap one another in the longitudinal direction 16. In this regard, no portion of any of the perforations in the first series 28 have the same distance to the body 14 in the longitudinal direction 16. Likewise, no portion of any of the perforations of the second series 30 share the same distance to the body 14 in the longitudinal direction 16.

Other designs of the resealable label 10 are possible in which the middle of the resealable label 10 may not tear when the peel tab 20 is pulled. To leave the tamper evident tabs 24 and 52 on the surface 56 and to prevent tearing of the middle of the resealable label 10 when removing the peel tab 20, the first and second series of perforations 28 and 30 may be angled as shown in the previously described exemplary embodiments. Additionally, the perforations of the first and second series of perforations 28, 30 may be provided so that they overlap in the lateral direction 40. This type of an arrangement may allow for the peel tab 20 to be removed while the only portion of the resealable label 10 that is torn is that of the first and second series of perforations 28 and 30. The peel tab 20 and the body 14 may remain intact when the resealable label 10 is initially opened.

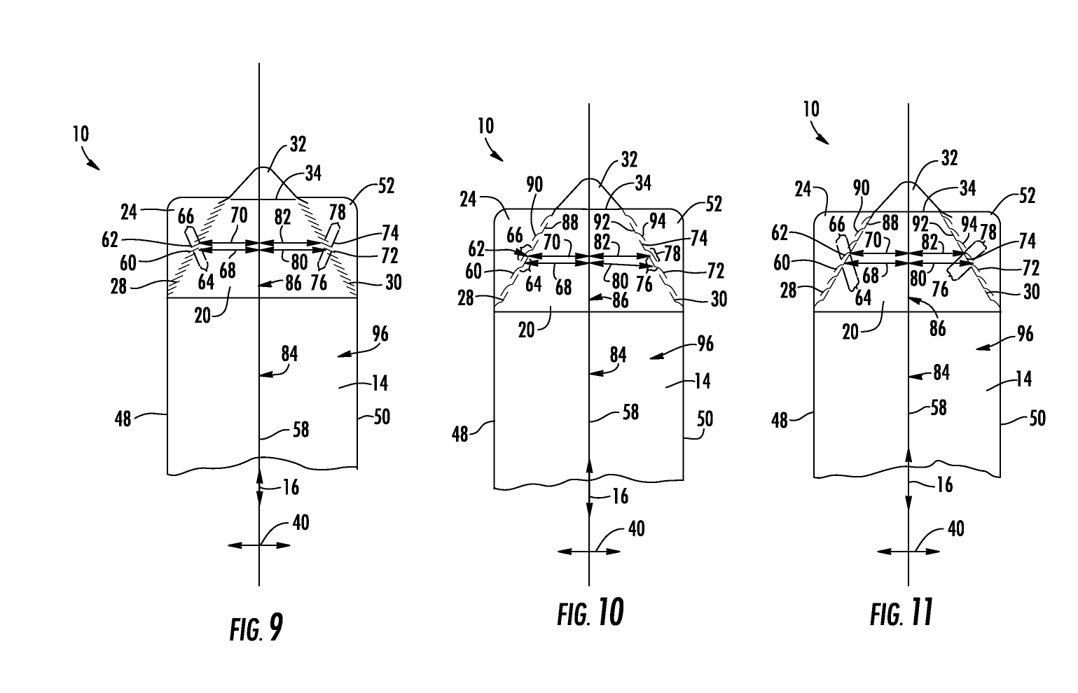

FIG. 9 illustrates one exemplary embodiment of the resealable label 10 in which the perforations of the first and second series of perforations 28 and 30 are shown in detail so as to illustrate their overlapping arrangement. FIGS. 10-13 show additional embodiments of the resealable label 10 in which the perforations are variously arranged in overlapping configuration. The body 14 may be arranged in manners previously discussed with respect to other embodiments of the resealable label 10, and the body is not shown in detail in FIGS. 9-13 as a repeat of this information is not necessary.

The perforations of the first and second series of perforations 28, 30 are all linear in shape without any additional shapes included. All of the perforations of the first and second series of perforations 28, 30 overlap such that successive perforations overlap. In some arrangements, every one of the successive perforations of the first and second series 28, 30 overlap, and in other arrangements of the resealable label 10, only two of the successive perforations of the first and/or second series 28, 30 overlap. Upon the pulling the grasping tab 32 and pulling the peel tab 20, the angled arrangement of the first and second series of perforations 28, 30 such that they both extend outboard in the lateral direction 40 away from the longitudinal centerline 58 in the direction of extension toward the body 14 helps to cause the peel tab 20 to tear so that the middle of the label 10 is not torn. The overlapping arrangement of the perforations of the first and second series of perforations 28, 30 may also help to prevent the middle of the resealable label 10 from tearing so that the peel tab 20 and body 14 are removed such that the middle of the resealable label 10 remains intact.

With reference to FIG. 9, a first perforation 60 and a second perforation 62 of the first series of perforations 28 are labeled for discussion of the overlapping arrangement. The first and second perforations 60 and 62 are successive in that they are next to one another in the plurality of perforations of the first series of perforations 28. A portion 64 of the first perforation 60 is noted, and portion 66 of the second perforation 62 is likewise identified. The first and second perforations 60, 62 overlap one another in that their portions 64 and 66 have the same distance 68 and 70 to the longitudinal centerline 58 in the lateral direction 40. As shown, the portion 64 is a distance 68 to the longitudinal centerline 58 in the lateral direction 40, and the portion 66 is a distance 70 to the longitudinal centerline 58 in the lateral direction 40. As the perforations 60, 62 have some portion 64, 66 that have the same distance to the longitudinal centerline 58, the successive portions 60, 62 overlap. It is also the case that certain portions of the first and second perforations 60, 62 do not have the same distance to the longitudinal centerline 58. For example, certain portions of the first perforation 60 are farther from the longitudinal centerline 58 in the lateral direction 40 than the entire second perforation 62. In a similar manner, certain portions of the second perforation 62 are closer to the longitudinal centerline 58 in the lateral direction 40 than the entire first perforation 60. However, the perforations 60, 62 are said to overlap one another as at least some part of the first and second perforations 60, 62 are located at the same distance from the longitudinal centerline 58.

Again, although the first and second perforations 60, 62 overlap one another, it may or may not be the case that all of these successive perforations of the first series 28 overlap. In some arrangements, a majority of the perforations of the first series 28 may overlap, while a minority of the perforations of first series 28 do not overlap. In other exemplary embodiments, all of the successive perforations of the first series of perforations 28 overlap one another. It is to be understood that as described herein the term “overlap” refers to successive perforations of the first and second series of perforations 28, 30. It may be the case that non-successive perforations overlap one another in the lateral direction 40, or it may be the case that in some exemplary embodiments all of the perforations of the first series of perforations 28 overlap one another such that at least some portion of all of the perforations have the same distance to the longitudinal centerline 58.

The second series of perforations 30 may be arranged in a similar manner. As shown in FIG. 9, a first perforation 72 and a second perforation 74 of the second series of perforations 30 are identified. The first perforation 72 has a portion 76, and the second perforation 74 has a portion 78. The first perforation 72 is successive to the second perforation 74 as the perforations 72, 74 are located immediately adjacent to one another and are successive perforations in the series of perforations 30 that extend from the second lateral edge 50 to grasping tab 32. The portion 76 is located a distance 80 from the longitudinal centerline 58 in the lateral direction 40. Portion 78 is located a distance 82 to the longitudinal centerline 58 in the lateral direction 40. Distances 80 and 82 are equal to one another, and the portions 76, 78 are located at the same distance from the longitudinal centerline 58. Certain portions of the perforations 72, 74 do not overlap one another. For example, the first perforation 72 has certain portions that are farther from the longitudinal centerline 58 than the entire second perforation 74. In a similar manner, the second perforation 74 has a portion that is located closer to the longitudinal centerline 58 than any part of the first perforation 72. All of the successive perforations of the second series of perforations 30 may overlap one another. In other embodiments, the second series of perforations 30 can be arranged so that only two of the successive perforations overlap, or so that a majority of the successive perforations overlap, or so that a minority of successive perforations overlap. Again, it is to be understood that as used herein the term “overlap” refers to two successive perforations of the series of second perforations 30 that have portions that share the same distance to the longitudinal centerline 58.

The longitudinal centerline 58 extends in the longitudinal direction 16 through the longitudinal center 84 of the body and the longitudinal center 86 of the peel tab 20. The grasping tab 32 may also be arranged with respect to the body 14 and peel tab 20 so that the longitudinal centerline 58 extends through the longitudinal center of the grasping tab 32. The first and second tamper evident tabs 24, 52 may be arranged so that the longitudinal centerline 58 does not extend through any portion of the tamper evident tabs 24, 52.

The perforations in the first and second series of perforations 28, 30 are all linear in shape but are not aligned end to end along a common line as was the case with the perforations in FIG. 8. As shown in FIG. 9, the perforations are parallel to one another but are not oriented so that they are arranged in a linear fashion. With reference to the perforations of the first series of perforations 28, the various perforations are all parallel to one another but are not arranged end to end such that an end of one perforation is closer to a portion of the next successive perforation that is not the end of the next successive perforation. However, it is to be understood that in some embodiments that an end of a perforation of the first series of perforations 28 may be closest to an end of the next successive perforation in the first series of perforations 28. However, all of the perforations may be arranged to that they are not standard, linear perforations that extend along a common line and are all arranged in an end-to-end fashion.

FIG. 10 discloses another exemplary embodiment of the resealable label 10 similar to that previously discussed but with perforations of the first and second series of perforations 28, 30 that are provided in a different manner. The first perforation 60 has a linear section 88 and a curved section 90. As such, the first perforation 60 is not completely linear in shape. All of the perforations of the first series of perforations 28 are shaped in a similar manner in that they have a linear section 88 and a curved section 90. Successive perforations 60 and 62 have portions 64 and 66 that are the same distance 68, 70 to the longitudinal centerline 58. Additionally, the successive perforations are arranged so that portions of the perforations 60, 62 likewise overlap in the longitudinal direction 16 such that they are the same distance from the body 14, or from a terminal end of the resealable label 10 in the longitudinal direction 16.

The second series of perforations 30 are also arranged so that they include a linear section 92 and a curved section 94. The successive perforations may overlap in the lateral direction 40, and may likewise overlap in the longitudinal direction 16. The second series of perforations 30 may be arranged in the same manner as the first series of perforations 28, and the first and second series of perforations 28, 30 are not arranged such that they are all linear perforations that extend in a common line and are arranged in an end-to-end manner.

FIG. 11 discloses another alternate arrangement of the resealable label 10 in which the perforations of the first and second series of perforations 28, 30 all have a linear section 88, 92 and a curved section 90, 94. The successive perforations of the series of perforations 28, 30 overlap in the lateral direction 40 and also overlap in the longitudinal direction 16. The perforations differ from those in FIG. 10 in that the linear sections 88, 92 are arranged almost in an end-to-end manner with one another as they are located extremely close to adjacent perforations. The curved sections 90, 94 are not arranged along a common line end-to-end but instead extend away from a common line formed by the linear sections 88, 92.

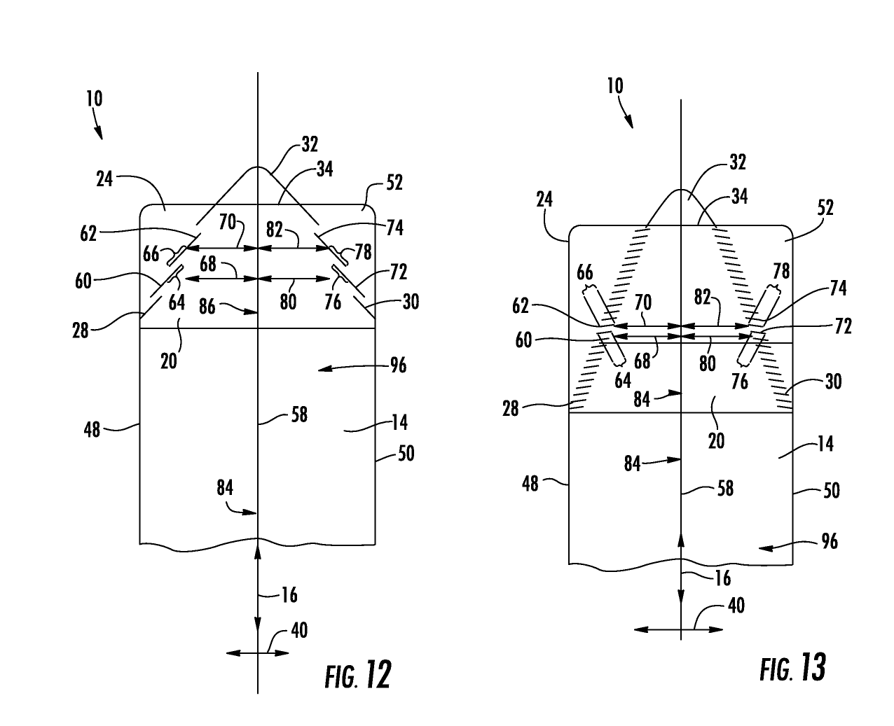

FIG. 12 discloses another embodiment of the resealable label 10 in which the perforations are completely linear in shape. The perforations overlap in the lateral direction 40 as the portion 64 of perforation 60 has the same distance 68 to the longitudinal centerline 58 as does the portion 66 of the successive second perforation 62. Distance 70 from the longitudinal centerline 58 to the portion 66 of the second perforation 62 is the same as distance 68. Although the successive perforations 60, 62 overlap in the lateral direction 40, they do not overlap in the longitudinal direction 16. As shown, an end of perforation 60 that is closest to the end of perforation 62 are not the same distance in the longitudinal direction 16 from the body 14. However, in other arrangements the second perforation 62 can be positioned in the longitudinal direction 16 so that a portion of the second perforation 62 is the same distance to the body 14 in the longitudinal direction 16 as a portion of the first perforation 60. Again, all of the successive perforations of the first series of perforations 28 may overlap one another, or less than all of the successive perforations of the first series 28 may overlap in other arrangements. The second series of perforations 30 may be arranged in a similar manner and a repeat of this information is not necessary.

FIG. 13 shows another alternative exemplary embodiment of the resealable label 10 in which the series of perforations 28, 30 are again provided so that they overlap. The number of perforations in the first and second series of perforations 28, 30 are greater than those previously illustrated and the length of the series of perforations 28, 30 in the longitudinal direction 16 is likewise greater than that of previous embodiments. Successive perforations 60, 62 of the first series 28 overlap one another in the lateral direction 40, and successive perforations 72, 74 in the second series 30 likewise overlap in the lateral direction 40. All of the perforations are linear in shape, and are arranged so that they are parallel to one another. In this regard, all of the perforations of the first series of perforations 28 are parallel to successive perforations, and all of the perforations in the second series of perforations 30 are likewise parallel. It is to be understood that the perforations may be variously designed in accordance with different exemplary embodiments of the resealable label 10 and that those illustrated are only exemplary.

The various components of the resealable label 10 can be integrally formed with one another and made as a single piece. The body 14, peel tab 20, tamper evident tabs 24, 52, and grasping tab 32 may all be a single integral piece, or these components can be different pieces and not integrally formed in various embodiments.

The sections of deadened adhesive, such as deadened adhesive section 38 and deadened adhesive section 46, can be formed by first starting with a label facestock material backed with adhesive and carried on a silicone coated paper liner. UV varnish can be applied to the adhesive at desired portions to cover the adhesive so that these portions do not have tackiness. These portions, for example 38 and 46, may in fact have adhesive present, but have been treated so that the adhesive does not have any tackiness and thus does not have any holding power. In other embodiments, the portions, such as deadened adhesive section 38 and deadened adhesive section 46, may be manufactured so that no adhesive is present at all in them. In this manner, the sections 38 and 46 are not treated with UV varnish or any other component to reduce their tackiness because they have no level of tact as formed.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

What is claimed:

1. A resealable label, comprising:
a body that extends in a longitudinal direction of the label, wherein the body has adhesive;
a peel tab that is adjacent to the body, wherein the peel tab has adhesive for releasable attachment;
a tamper evident tab that is adjacent to the peel tab, wherein perforations are between the peel tab and the tamper evident tab, wherein the tamper evident tab has adhesive; and
a grasping tab adjacent to the peel tab, wherein pulling of the grasping tab causes the peel tab to be torn from the tamper evident tab.

2. The resealable label as set forth in claim 1, wherein the peel tab is triangular in shape with a truncated end that is contiguous with the grasping tab, wherein the peel tab has the adhesive of the peel tab arranged in a series of linear strips separated by a series of deadened adhesive sections of the peel tab.

3. The resealable label as set forth in claim 2, wherein the resealable label has a lateral direction that is perpendicular to the longitudinal direction, wherein the series of linear strips of the adhesive of the peel tab all extend in the lateral direction, and wherein the series of deadened adhesive sections of the peel tab all extend in the lateral direction, and wherein from 10-16 linear strips of the adhesive of the peel tab are present.

4. The resealable label as set forth in claim 2, wherein the series of linear strips of the adhesive of the peel tab all extend in the longitudinal direction, and wherein the series of deadened adhesive sections of the peel tab all extend in the longitudinal direction.

5. The resealable label as set forth in claim 1, wherein the peel tab is triangular in shape with a truncated end that is contiguous with the grasping tab, wherein the peel tab has the adhesive of the peel tab arranged in a series of circles that are evenly distributed across the peel tab separated by areas of deadened adhesive sections of the peel tab.

6. The resealable label as set forth in claim 1, wherein the body has a deadened adhesive section that does not have any tact due to UV deadening, wherein the body has an adhesive section that does include adhesive, wherein the deadened adhesive section of the body is between the peel tab and the adhesive section of the body, wherein the deadened adhesive section of the body is adjacent the peel tab.

7. The resealable label as set forth in claim 1, wherein the resealable label has a lateral direction that is perpendicular to the longitudinal direction, wherein the perforations are a first series of perforations that extend from a first lateral edge of the resealable label in the longitudinal direction away from the body and in the lateral direction inboard to the grasping tab;
wherein a second series of perforations are present and are between the peel tab and a second tamper evident tab, wherein the second tamper evident tab has adhesive, wherein the second series of perforations extend from a second lateral edge of the resealable label in the longitudinal direction away from the body and in the lateral direction inboard to the grasping tab, wherein pulling of the grasping tab causes the peel tab to be torn from the second tamper evident tab;
wherein the tamper evident tab and the second tamper evident tab remain on a surface of a container after the peel tab is removed from the surface of the container.

8. The resealable label as set forth in claim 1, wherein the resealable label has a longitudinal centerline that is located at the center of the body and peel tab in a lateral direction of the resealable label;
wherein the perforations are a first series of perforations in which successive perforations of the first series of perforations overlap in that portions of successive perforations of the first series of perforations have the same distance to the longitudinal centerline in the lateral direction;
further comprising a second tamper evident tab that is adjacent to the peel tab, wherein the second tamper evident tab has adhesive, wherein a second series of perforations are between the peel tab and the second tamper evident tab, wherein successive perforations of the second series of perforations overlap in that portions of successive perforations of the second series of perforations have the same distance to the longitudinal centerline in the lateral direction.

9. A resealable label, comprising:
a body that extends in a longitudinal direction of the label, wherein the body has adhesive, wherein the label has a lateral direction that is perpendicular to the longitudinal direction, wherein the label has a longitudinal centerline that is located at a center of the body in the lateral direction of the resealable label;
a peel tab that is adjacent to the body, wherein the peel tab has adhesive for releasable attachment, wherein the longitudinal centerline is located at a center of the peel tab in the lateral direction of the resealable label;
a first series of perforations that extend away from the body in the longitudinal direction and extend towards the longitudinal centerline in the lateral direction upon extension away from the body in the longitudinal direction, wherein successive perforations of the first series of perforations overlap in that portions of successive perforations of the first series of perforations have the same distance to the longitudinal centerline in the lateral direction; and
a second series of perforations that extend away from the body in the longitudinal direction and extend towards the longitudinal centerline in the lateral direction upon extension away from the body in the longitudinal direction, wherein successive perforations of the second series of perforations overlap in that portions of successive perforations of the second series of perforations have the same distance to the longitudinal centerline in the lateral direction;
wherein the first series of perforations and the second series of perforations are on opposite sides of the longitudinal centerline.

10. The resealable label as set forth in claim 9, wherein each individual perforation of the first series of perforations is line shaped, and wherein each individual perforation of the second series of perforations is line shaped.

11. The resealable label as set forth in claim 9, wherein each individual perforation of the first series of perforations has a linear section and a curved section, and wherein each individual perforation of the second series of perforations has a linear section and a curved section.

12. The resealable label as set forth in claim 9, further comprising:
a first tamper evident tab adjacent to the peel tab, wherein the first series of perforations are between the peel tab and the first tamper evident tab, wherein the first tamper evident tab has adhesive;
a second tamper evident tab adjacent to the peel tab, wherein the second series of perforations are between the peel tab and the second tamper evident tab, wherein the second tamper evident tab has adhesive;
wherein pulling of the peel tab causes tearing of the perforations of the first and second series of perforations to cause the peel tab to be torn from the first and second tamper evident tabs, wherein the first and second tamper evident tabs remain on a surface of a container when the peel tab is removed from the surface of the container.

13. The resealable label as set forth in claim 12, wherein the first tamper evident tab and the second tamper evident tab are both triangular in shape and are on opposite sides of the longitudinal centerline.

14. The resealable label as set forth in claim 9, further comprising a grasping tab adjacent to the peel tab, wherein pulling of the grasping tab causes the pulling of the peel tab, wherein the peel tab is triangular in shape with a truncated end that is contiguous with the grasping tab.

15. The resealable label as set forth in claim 9, wherein the peel tab has the adhesive of the peel tab arranged in a series of linear strips separated by a series of deadened adhesive sections of the peel tab, wherein the series of linear strips of the adhesive of the peel tab all extend in the lateral direction and are parallel to one another, and wherein the series of deadened adhesive sections of the peel tab all extend in the lateral direction and are parallel to one another, and wherein from 10-16 linear strips of the adhesive of the peel tab are present.

16. The resealable label as set forth in claim 9, wherein the peel tab has the adhesive of the peel tab arranged in a series of linear strips separated by a series of deadened adhesive sections of the peel tab, wherein the series of linear strips of the adhesive of the peel tab all extend in the longitudinal direction and are parallel to one another, and wherein the series of deadened adhesive sections of the peel tab all extend in the longitudinal direction and are parallel to one another.

17. The resealable label as set forth in claim 9, wherein the body has a deadened adhesive section, wherein the body has an adhesive section that does include the adhesive, wherein the deadened adhesive section of the body is between the peel tab and the adhesive section of the body, wherein the deadened adhesive section of the body is adjacent the peel tab.

18. The resealable label as set forth in claim 9, wherein an entire lower surface of the body is covered with the adhesive.

19. A resealable label, comprising:
a body that extends in a longitudinal direction of the label, wherein the body has adhesive;
a peel tab that is adjacent to the body, wherein the peel tab has adhesive for releasable attachment, wherein the peel tab is triangular in shape with a truncated end that is not adjacent to the body;
a first tamper evident tab that is adjacent to the peel tab, wherein a first series of perforations are between the peel tab and the first tamper evident tab, wherein the first tamper evident tab has adhesive;
wherein the perforations of the first series of perforations are arranged so that successive perforations of the first series of perforations overlap and are not each linear in shape oriented in a straight line from end to end and all extending individually along a common line;
a second tamper evident tab that is adjacent to the peel tab, wherein a second series of perforations are between the peel tab and the second tamper evident tab, wherein the second tamper evident tab has adhesive;
wherein the perforations of the second series of perforations are arranged so that successive perforations of the second series of perforations overlap and are not each linear in shape oriented in a straight line from end to end and all extending individually along a common line.
